(19) United States
(12) Patent Application Publication
(10) Pub. No.: US 2004/0204569 A1
(43) Pub. Date: Oct. 14, 2004

(54) Separation material, column having that separation material, and use thereof for purifying proteins

(76) Inventors: Edmund Radmacher, Duren (DE); Klaus Moller, Eschweiler (DE); Helmut Riering, Kerpen (DE)

Correspondence Address: Joseph W. Berenato, III, Liniak, Berenato & White, LLC, Suite 240, 6550 Rock Spring Drive, Bethesda, MD, 20817, US

(21) Appl. No.: 10/757,550

(22) Filed: Jan. 15, 2004

(30) Foreign Application Priority Data
Jan. 16, 2003 (DE) 203 00 703.4

(51) Int. Cl. C07K 1/22

(52) U.S. Cl. 530/413

(57) ABSTRACT

The invention concerns a separation matrix for purifying His-tag proteins by the introduction of alkyl substituents into a TED molecule, if applicable by the use of support materials having an average pore width >10⁻⁷ m (1000 Å).

### CROSS-REFERENCE TO RELATED APPLICATIONS AND CLAIM TO PRIORITY

This application claims the benefit of priority under 35 U.S.C. § 119 to utility model application number 203 00 703.4, filed Jan. 16, 2003 in the Federal Republic of Germany.

### FIELD OF THE INVENTION

The present invention concerns a separation matrix, a column having that separation material, and the use thereof for purifying His-tag proteins.

### BACKGROUND OF THE INVENTION

The separation matrix is used in immobilized metal-ion affinity chromatography (IMAC).

The principle is based on the reversible binding of certain amino acids, such as histidine, tryptophan, tyrosine, or phenylalanine, to immobilized metal ions such as Co²⁺ or Ni²⁺. Immobilization is accomplished by way of a chelating group that is covalently bound to a support matrix. The bond between the amino-acid groups of a protein and the metal ions can be undone by lowering the pH value or by way of a displacement reaction using imidazole. IMAC has developed into one of the most important methods for purifying recombinant proteins that are fused at the N- or C-terminus to a polyhistidine peptide. These are therefore called “polyhistidine fusion proteins.” A large number of polyhistidine peptides exist, differing in terms of the number and arrangement of the histidine groups and therefore in terms of affinity for the IMAC separation material, e.g. (H)ₙ, (H—X)ₙ, (H—X₃—H)ₙ, where H stands for histidine and X can be any amino acid.

A variety of chelating ligands can be used to immobilize the metal ions, for example iminodiacetic acid (IDA), nitrilotriacetic acid (NTA), carboxymethylated aspartate (CM-Asp), and tris(carboxymethyl)ethylenediamine (TED). Divalent metal ions are retained by the IDA group via three coordinate bonds; this is correspondingly called a “three-dentate ligand.” The chelate complex has two extra coordination sides in order to bind the side chain of an amino acid, for example histidine. Because the metal ions are relatively weakly bound, they can easily be rinsed out; the phenomenon is referred to as “metal leaching.” The loss of metal ions results in a decreased binding capacity and can cause problems in downstream applications.

NTA and CM-Asp bind metal ions via four coordination sides and thus represent four-dentate ligands. The stronger bonding means that leaching of metal ions is decreased, although still problematic.

Tris(carboxymethyl)ethylenediamine (TED) is a five-dentate ligand that binds metal ions via five coordination sides (Porath, J. and Olin, B. 1983, Biochemistry 22:1621-1630):

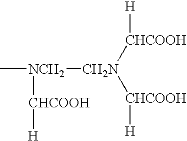

The metal-chelate complexes formed with the metal ions, in particular with Ni²⁺ ions, are extremely stable, so that the metal ions essentially do not leach out. Because only one coordination sides is available for binding the protein, TED matrices possess a low affinity for the corresponding proteins; this results in higher selectivity and thus a lower binding capacity for proteins.

The chelating groups are bound to support matrix via a “spacer.” Soft-gel support media such as agarose, or dimensionally stable support materials such as highly crosslinked polymer materials or silica gels, are particularly suitable as support matrix. Only support matrices having an average pore size (pore diameter) of 8×10⁻⁸ m at most are used, since support matrices having an average pore size greater than 8×10⁻⁸ m are regarded as having lower binding capacities for proteins. Figueroa, A., Corradini, C., Feibush, B., and Karger, B. L. 1986, Journal of Chromatography 371:335-52, for example, propose using support matrices having an average pore size of 3×10⁻⁸ m (300 Å). It is disadvantageous that separation media based on such support matrices often exhibit an unsatisfactory binding capacity for proteins, in particular for large recombinant proteins.

### SUMMARY OF THE INVENTION

It is the object of the present invention to make available a separation matrix, in particular for immobilized metal-ion affinity chromatography (IMAC), that exhibits an improved binding capacity for proteins, in particular for large recombinant proteins; that moreover has high selectivity with regard to the proteins; and that exhibits little “metal leaching.”

This object is achieved, according to the present invention, by a separation matrix for purifying His-tag proteins that contains a porous support on which a chelating group is bound according to the general formula I below:

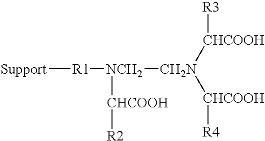

where R1 is a branched or unbranched alkyl group containing 1 to 20 carbon atoms, an aralkyl group containing 1 to 20 carbon atoms, an aryl group containing 1 to 20 carbon atoms, or a heteroaryl group containing 1 to 20 carbon atoms as well as at least one of the elements N, S, O, P; R2, R3, and R4 are identical or different and represent hydrogen, branched or unbranched alkyl groups containing 1 to 20 carbon atoms, aralkyl groups containing 1 to 20 carbon atoms, and/or aryl groups containing 6 to 18 ring atoms; and the support has an average pore size (pore diameter) larger than 10⁻⁷ m (1000 Å).

The invention is based on the finding that the binding capacity of the separation media for proteins, in particular for large recombinant proteins, is improved by the introduction of alkyl substituents into the TED molecule and by the use of support media having an average pore size larger than 10⁻⁷ m (1000 Å). This is surprising in that even bulky proteins—for example the recombinant GFP protein that, with a cylindrical shape, has a height of only 4.2×10⁻⁹ m (42 Å) and a diameter of 2.4×10⁻⁹ m (24 Å)—can readily penetrate even into pores that are considerably smaller than 10⁻⁷ m (1000 Å). One would thus actually have expected that an enlargement of the pores should by no means increase the accessibility of the pores for proteins and therefore not improve the binding capacity, but in fact should worsen it because of the smaller surface area.

The object is, however, achieved by way of a separation matrix for purifying His-tag proteins that contains a porous medium on which a chelating group is bound according to the general formula II below:

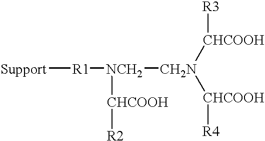

where R1 is a branched or unbranched alkyl group containing 1 to 20 carbon atoms, an aralkyl group containing 1 to 20 carbon atoms, an aryl group containing 1 to 20 carbon atoms, or a heteroaryl group containing 1 to 20 carbon atoms as well as at least one of the elements N, S, O, P; and R2, R3, and R4 are identical or different and represent hydrogen, branched or unbranched alkyl groups containing 1 to 20 carbon atoms, aralkyl groups containing 1 to 20 carbon atoms, and/or aryl groups containing 6 to 18 ring atoms, with the stipulation that no more than two of the groups R2, R3, and R4 are present as hydrogen.

The greater binding capacity guaranteed by the invention has the advantage that for an identical yield, substantially smaller quantities of separation media are necessary as compared with the existing art, thereby making possible a more economical purification method. The separation material is moreover characterized by high selectivity, with the consequence that a target protein is obtained at high purity. Nonspecific bonds are suppressed, and foreign proteins are correspondingly effectively depleted.

The length of the alkyl substituent representing R2, R3, and/or R4 critically determines the affinity between the chelating group and the proteins to be purified. Proteins that are poorly bound because of a low affinity for the TED standard media can be purified at higher yield by suitable selection of the alkyl groups. The separation material according to the present invention is suitable in particular for effective purification of recombinant His-tag proteins.

The average pore sizes were determined by mercury porosimetry (Porotec GmbH), Hofheim), and the pore size distribution was ascertained using the Washburn equation (E. W. Washburn, Proc. Nat. Acad. Sci. USA 1992. 7:115).

In a preferred embodiment of the invention, the support material has an average pore size larger than 1.2×10⁻⁷ m (1200 Å). Pore sizes from 1.2×10⁻⁷ to 2×10⁻⁷ m (1200 to 2000 Å) are, however, particularly preferred.

R1 can be, for example, be present as:

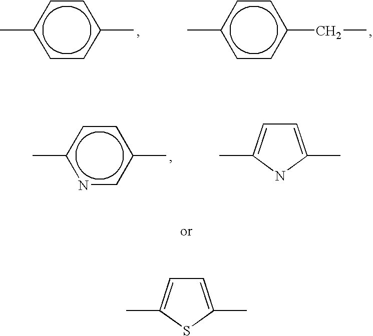

Preferably either R2, R3, and/or R4 is present as an alkyl substituent.

R2, R3, and R4 are, as a rule, the same substituent in each case. R2, R3, and R4 can be present as a methyl, ethyl, n-propyl, i-propyl, n-butyl, isobutyl, octyl, or octadecyl group.

It is also possible, however, for R2, R3, and R4 to be present as aryl and/or aralkyl groups, such as phenyl or benzyl groups.

It is advantageous to use pressure-stable and dimensionally stable support media, which have the advantages that they can be dispensed easily and reproducibly; that they form a stable bed in the corresponding chromatographic columns; that they are stable in storage in dry form; and that because of their stable pore structure and particle shape, they equilibrate rapidly and with no change in volume. A stable bed chromatographic offers the advantage that during chromatography, the recombinant proteins come into contact with a particularly large number of binding sides as they pass through the column. For this reason, a slower flow through the separation medium during chromatography is sufficient to ensure optimum binding of the recombinant proteins to the support matrix. Inorganic materials such as silica material, especially silica gel, are used in particular as pressure-stable and dimensionally stable support matrices. As an alternative thereto, however, organic support media such as crosslinked polymers are also a possibility. These polymers can be present, for example, as polystyrene-divinyl resins or as methacrylate resins.

### BRIEF DESCRIPTION OF THE FIGURES

The invention will be explained in more detail below with reference to exemplary embodiments that refer to the accompanying drawings, in which:

FIG. 1 is a bar chart depicting the protein mass bound to separation material according to the present invention and to separation media according to the existing art, as a function of the pore size of the respective separation material;

FIG. 2 is a bar chart depicting the protein mass bound to separation medium according to the present invention and to separation media according to the existing art;

FIG. 3 is a bar chart depicting the mass of bound protein as a function of various separation of the “TED” type according to the present invention; and

FIG. 4 is a bar chart depicting the mass of the bound protein to separation media as a function of the size of the column bed used, taking the example of two different “TED” type separation media of the type according to the present invention.

### DETAILED DESCRIPTION OF THE PREFERRED EMBODIMENT(S)

### EXAMPLE 1

Binding the precursor of the chelating group to the support—Reacting silica gel with 3-(2-aminoethylamino)propyltrimethoxysilane.

100 g silica gel having an average pore size of 1.5×10⁻⁷ m (1500 Å) (alternatively, 2.4×10⁻⁸ (240 Å)) and a particle size of 50 μm (alternatively, 20 and 120 μm) was suspended in 400 ml absolute xylene. 20 ml 2-aminoethylaminopropyltrimethoxysilane was added and heated to boiling for 16 hours. The silica gel was filtered off, washed with methylene chloride, methanol and water, and then dried.

### EXAMPLE 2

Forming the immobilized chelating group according to formula I with (R1=CH₂—CH₂—CH₂—), R2=R3=R4═H—Reacting the silica gel of Example 1 with bromoacetic acid—Producing the Ni-TED silica E separation material

100 g 3-(2-aminoethylamino)propyltrimethoxysilane-modified silica gel from Example 1, and 24 g sodium iodide, were stirred into 600 ml methanol. A solution of 42.4 g 2-bromoacetic acid and 12.2 g sodium hydroxide in 20 ml water was added and heated to boiling for 16 hours. The silica gel was filtered off and washed with methylene chloride, methanol, water, 0.1 M nickel sulfate solution, and water.

### EXAMPLE 3

Forming the immobilized chelating group according to formula II with (R1=CH₂—CH₂—CH₂—), R2=R3=R4=CH₃—Reacting the silica gel of Example 1 with 2-propionic acid—Producing the Ni-TED silica P separation material

100 g 3-(2-aminoethylamino)propyltrimethoxysilane-modified silica gel from Example 1, and 24 g sodium iodide, were stirred into 600 ml methanol. A solution of 46.7 g 2-bromopropionic acid and 12.2 g sodium hydroxide in 20 ml was added and heated to boiling for 16 hours. The silica gel was filtered off and washed with methylene chloride, methanol, water, 0.1 M nickel sulfate solution, and water.

### EXAMPLE 4

Forming the immobilized chelating group according to formula II with (R1=CH₂—CH₂—CH₂—), R2=R3=R4=CH₂—CH₃—Reacting the silica gel of Example 1 with 2-bromobutyric acid—Producing the Ni-TED silica B separation material.

100 g 3-(2-aminoethylamino)propyltrimethoxysilane-modified silica gel from Example 1, and 24 g sodium iodide, were stirred into 600 ml methanol. A solution of 51.0 g 2-bromobutyric acid and 12.2 g sodium hydroxide in 20 ml water was added and heated to boiling for 16 hours. The silica gel was filtered off and washed with methylene chloride, methanol, water, 0.1 M nickel sulfate solution, and water.

### EXAMPLE 5

Forming the immobilized chelating group according to formula II with (R1=CH₂—CH₂—CH₂—), R2=R3=R4=CH₂—CH₂—CH₃—Reacting the silica gel of Example 1 with 2-bromohexanoic acid—Producing the Ni-TED silica H separation material.

100 g 3-(2-aminoethylamino)propyltrimethoxysilane-modified silica gel from Example 1, and 24 g sodium iodide, were stirred into 600 ml methanol. A solution of 59.5 g 2-bromohexanoic acid and 12.2 g sodium hydroxide in 20 ml water was added and heated to boiling for 16 hours. The silica gel was filtered off and washed with methylene chloride, methanol, water, 0.1 M nickel sulfate solution, and water.

### EXAMPLE 6

Binding of Polyhistidine Fusion Proteins to IMAC Separation Materials Having Various Pore Sizes

The chambers of a 96-chamber filtration unit were filled with the following chromatographic media:

75 mg of the Ni-TED silica E obtained according to Example 2, having an average pore size of 1.5×10⁻⁷ m (1500 Å) and a particle diameter of 50 μm;

75 mg of the Ni-TED silica E obtained according to Example 2, having an average pore size of 2.4×10⁻⁸ m (240 Å) and a particle diameter of 50 μm;

75 Ni-TED silica of Active Motif, having an average pore size of 7.8×10⁻⁸ m (780 Å) and a particle diameter of 50 μm.

The filtration unit was placed onto a vacuum chamber (MACHEREY-NAGEL) in order to draw the solutions named below through the separation matrix. After equilibration with 2 ml buffer (50 mM Tris HCl, 300 mM NaCl, pH 8) clarified Escherichia coli lysate that contained 6×HN-GFPuv recombinant protein was applied to the silica matrix. 6×HN-GFPuv recombinant protein is a variant of Green Fluorescent Protein that is fused with a peptide containing six histidines (6×HN, BD Clontech). While the lysate was being drawn through the chromatographic bed, the protein became bound to the separation matrix. The quantity of histidine-tagged Green Fluorescent Protein in the clear lysate and in the through flow was determined by fluorescence measurement (excitation: 360 nm; emission: 530 nm). Subtracting the values for the flow through and for the lysate yielded the quantity of Green Fluorescent Protein that had bound to the separation matrix.

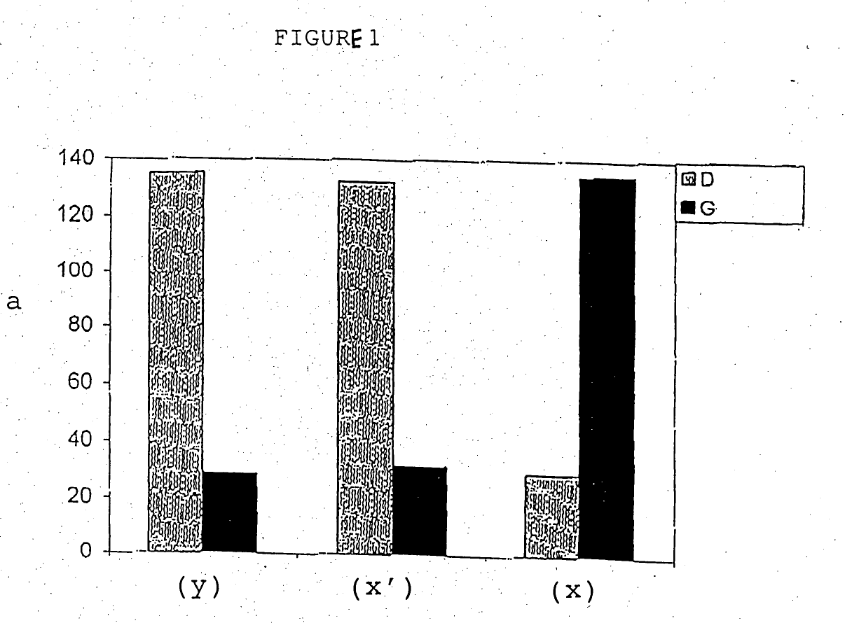

The experimental results are illustrated in FIG. 1, which shows the mass of 6×HN-GFPuv protein bound to Ni-TED silica as a function of the average pore size of the separation media. In the Figure, a denotes μg of 6×HN-GFPuv, y denotes 780 Å Ni-TED silica (Active Motif), x′ denotes 240 Å Ni-TED silica E according to Example 2, x denotes 1500 Å Ni-TED silica E according to Example 2, D denotes through flow, and G denotes bound.

Only 30 μg (18%) of the applied quantity of protein (165 μg) was bound to the media according to the existing art, namely Ni-TED silica having an average pore width of 2.4×10⁻⁸ m (240 Å) and Ni-TED silica having an average pore width of 7.8×10⁻⁸ m (780 Å) (Active Motif). In contrast to this, 135 μg (82%) was bound to the separation medium according to the present invention (Ni-TED silica E), which has an average pore diameter of 1.5×10⁻⁷ m (1500 Å). This is approximately 4.5 times the protein mass bound to the small-pore separation material according to the existing art. The experiment shows that an enormous increase in binding capacity can be achieved by enlarging the average pore size from 7.8×10⁻⁸ m (780 Å) to 1.5×10⁻⁷ m (1500 Å).

### EXAMPLE 7

Binding of polyhistidine fusion proteins to agarose- and silica gel-based IMAC separation media.

The experiment was conducted as described in Example 6, the following separation media being used:

75 mg of the Ni-TED silica E obtained according to Example 2, having an average pore width of 1.5×10⁻⁷ m (1500 Å) and a particle diameter of 50 μm;

100 μl (bed volume, corresponding to approx. 100 mg) of Ni—NTA Superflow of Qiagen, which is a soft agarose gel having a particle diameter of 80 μm.

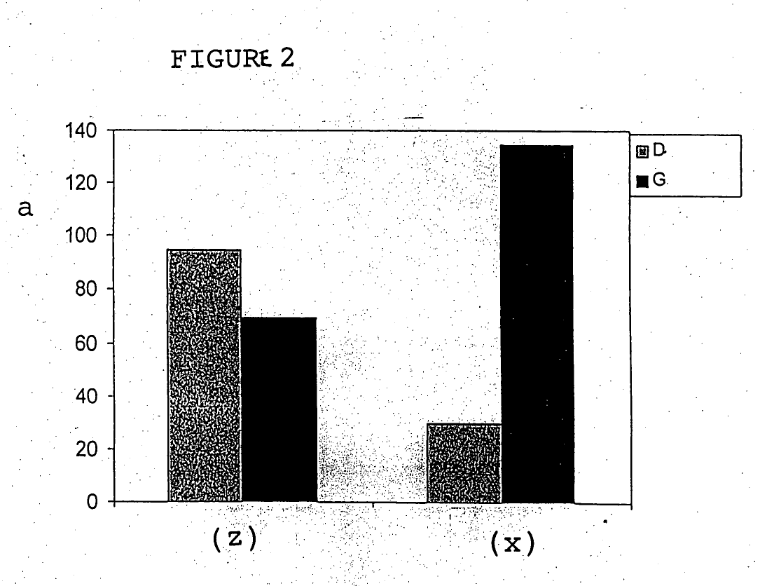

The result of this experiment is depicted in FIG. 2. It shows the masses of 6×HN-GFPuv protein bound to the Ni-TED silica and Ni—NTA Superflow separation media; a denotes μg of 6×HN-GFPuv, z denotes Ni—NTA Superflow (Qiagen), x denotes Ni-TED silica E (1500 Å), D denotes through flow, and G denotes bound.

The Ni—NTA Superflow (Qiagen) soft gel support matrix binds 70 μg of the recombinant protein; a sizable 95 μg ends up in the through flow (applied quantity: 165 μg). In contrast to this, almost twice that amount is bound to the Ni-TED silica E hard gel matrix according to the present invention having an average pore size of 1.5×10⁻⁷ m (1500 Å). This example shows that when the soft gel is used, a slow flow through the chromatographic column is not sufficient for optimum protein binding to the separation matrix. Better protein binding can be achieved only by laborious shaking or repeated resuspension. This shows that the use of hard gel support media is advantageous compared to soft gels.

### EXAMPLE 8

Binding of polyhistidine fusion proteins to IMAC separation media having TED and TED modifications as the chelating group

The experiment was performed in accordance with Example 6, using 100 mg of each of the Ni-TED silica separation media (E, P, B, and H) synthesized in Examples 2 through 5, which had pore diameters of 1.5×10⁻⁷ m (1500 Å) and a particle size of 50 μm. The recombinant protein used was Green Fluorescent Protein with a HAT polyhistidine peptide (BD Clontech). This peptide contains six histidines, between each of which one to three further amino acids are introduced. The HAT peptide has a lesser affinity for TED separation materials as compared with the 6×HN peptide (Examples 6, 7).

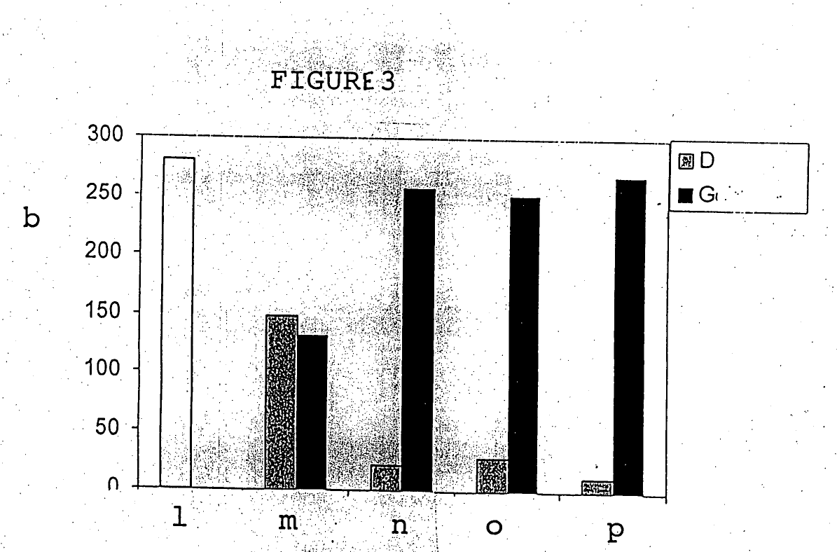

The result of the experiment is depicted in FIG. 3, which shows the quantity of HAT-GFPuv protein bound to Ni-TED silica matrix and its modifications. In FIG. 3, b denotes fig of HAT-GFPuv, 1 denotes lysate, m denotes Ni-TED silica E, n denotes Ni-TED silica P, o denotes Ni-TED silica B, p denotes Ni-TED silica H, D denotes through flow, and G denotes bound.

The Ni-TED silica E separation matrix binds only 130 μg (47%) of the applied quantity of protein (280 μg), and 150 μg (53%) ends up in the flow through. In contrast to this, only 4 to 10% of the protein is detectable in the flow through from the Ni-TED silica P, B, and H separation materials. The proportion of bound protein increases correspondingly to 92 to 96%. This experiment shows that the separation media having the modified TED groups (Ni-TED P, B, H) have a much higher affinity for the protein than does the material having the unmodified TED group (Ni-TED silica E). These modified TED groups are consequently particularly well suited for binding polyhistidine fusion proteins that, as shown in this example, bind very poorly to the standard TED group.

### EXAMPLE 9

Binding of Polyhistidine Fusion Proteins to IMAC Separation Materials Having TED and TED Modifications as Chelating Groups, as a Function of the Size of the Column Bed

The experiment was performed in accordance with Example 6, Ni-TED silica E and Ni-TED silica P being used in different quantities (150, 120, 90, 60 mg) (average pore size 1.5×10⁻⁷ m (1500 Å), particle size 50 μm). The bacterial lysate contained 380 μg of the 6×HN-GFPuv recombinant protein.

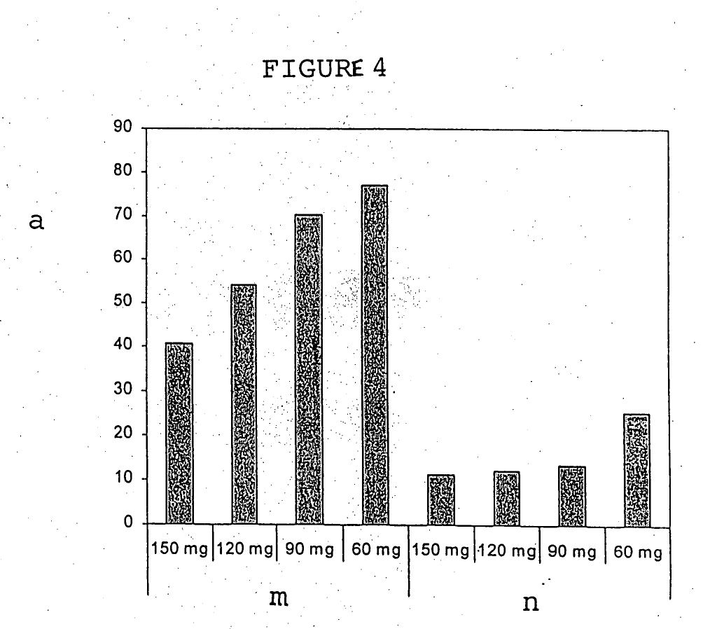

The results of this experiment are depicted in FIG. 4. It shows, for the use of the Ni-TED silica E and P separation materials, the non-bound quantity of 6×HN-GFPuv protein in the flow through as a function of the size of the column bed; a denotes μg of 6×HN-GFPuv, m denotes Ni-TED silica E, and n denotes Ni-TED silica P.

When the Ni-TED silica E separation material is used, a decrease from 150 to 60 mg in the amount of separation matrix used causes the proportion of non-bound protein in the flow through to almost double. In contrast, with the use of the Ni-TED silica P support material, which has a modified TED group, losses in the flow through are extremely small. This experiment shows that the separation matrix having the modified TED group has a greater binding capacity than the standard TED material, making it possible to work with less separation material.

We claim:

1. A separation matrix for purifying His-tag proteins that contains a porous support on which a chelating group is bound according to the general formula I below: 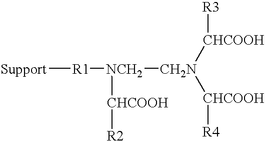
where R1 is a branched or unbranched alkyl group containing 1 to 20 carbon atoms, an aralkyl group containing 1 to 20 carbon atoms, an aryl group containing 1 to 20 carbon atoms, or a heteroaryl group containing 1 to 20 carbon atoms as well as at least one of the elements N, S, O, P;
R2, R3, and R4 are identical or different and represent hydrogen, branched or unbranched alkyl groups containing 1 to 20 carbon atoms, aralkyl groups containing 1 to 20 carbon atoms, and/or aryl groups containing 6 to 18 ring atoms; and
the support has an average pore width larger than 10⁻⁷ m (1000 Å).

2. The separation matrix as defined in claim 1, wherein the support material has an average pore size greater than 1.2×10⁻⁷ m (1200 Å).

3. The separation matrix as defined in claim 1, wherein the support material has an average pore size of 1.2×10⁻⁷ m (1200 Å) to 2×10⁻⁷ m (2000 Å).

4. A separation matrix for purifying His-tag proteins that contains a porous support on which a chelating group is bound according to the general formula II below: 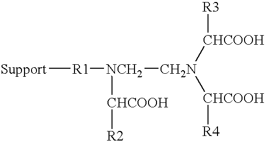
where R1 is a branched or unbranched alkyl group containing 1 to 20 carbon atoms, an aralkyl group containing 1 to 20 carbon atoms, an aryl group containing 1 to 20 carbon atoms, or a heteroaryl group containing 1 to 20 carbon atoms as well as at least one of the elements N, S, O, P; and
R2, R3, and R4 are identical or different and represent hydrogen, branched or unbranched alkyl groups containing 1 to 20 carbon atoms, aralkyl groups containing 1 to 20 carbon atoms, and/or aryl groups containing 6 to 18 ring atoms, with the stipulation that no more than two of the groups R2, R3, and R4 are present as hydrogen.

5. The separation matrix as defined in claim 1, wherein R2, R3, and R4 are the same substituent in each case.

6. The separation matrix as defined in claim 1, wherein R2, R3, and R4 are present as a methyl, ethyl, n-propyl, i-propyl, n-butyl, isobutyl, octyl, or octadecyl group.

7. The separation matrix as defined in claim 1, wherein the support is an inorganic matrix.

8. The separation matrix as defined in claim 1, wherein the support is present in the form of silica, in particular silica gel.

9. A column that contains a separation matrix according to claim 1.

10. Use of the separation matrix as defined in claim 1, for purifying His-tag proteins.

11. The separation matrix as defined in claim 4, wherein R2, R3, and R4 are the same substituent in each case.

12. The separation matrix as defined in claim 4, wherein R2, R3, and R4 are present as a methyl, ethyl, n-propyl, i-propyl, n-butyl, isobutyl, octyl, or octadecyl group.

13. The separation matrix as defined in claim 4, wherein the support is an inorganic material.

14. The separation matrix as defined in claim 4, wherein the support is present in the form of silica material, in particular silica gel.

15. A column that contains a separation matrix according to claim 4.

16. Use of the separation matrix as defined in claim 4, for purifying His-tag proteins.
